(19) United States
(12) Patent Application Publication
(10) Pub. No.: US 2020/0394982 A1
(43) Pub. Date: Dec. 17, 2020

(54) Display Luminance Adjustment Method and Electronic Device

(71) Applicant: Huawei Technologies Co., Ltd., Shenzhen (CN)

(72) Inventors: Shuncai Zhong, Shenzhen (CN); Yihua Zeng, Shenzhen (CN); Jian Liu, Shenzhen (CN); Jiafeng Zhu, Shanghai (CN)

(21) Appl. No.: 17/004,620

(22) Filed: Aug. 27, 2020

Related U.S. Application Data
(63) Continuation of application No. PCT/CN2019/075806, filed on Feb. 22, 2019.

(30) Foreign Application Priority Data
Feb. 28, 2018 (CN) 201810166643.1

(51) Int. Cl. G09G 5/10

(52) U.S. Cl. CPC G09G 5/10; G09G 2360/144; G09G 2320/0247; G09G 2360/141; G09G 2320/0646

(57) ABSTRACT

A display luminance adjustment method and an electronic device, where the display luminance adjustment method includes obtaining an initial luminance value of a display screen, obtaining an ambient light signal, determining a target luminance value of the display screen based on the ambient light signal, obtaining a target pixel value of a to-be-displayed image based on the initial luminance value, the target luminance value, and a current pixel value of the to-be-displayed image, and presenting the to-be-displayed image on the display screen based on the target pixel value of the to-be-displayed image.

### CROSS-REFERENCE TO RELATED APPLICATIONS

This application is a continuation of International Patent Application No. PCT/CN2019/075806 filed on Feb. 22, 2019, which claims priority to Chinese Patent Application No. 201810166643.1 filed on Feb. 28, 2018. The disclosures of the aforementioned applications are hereby incorporated by reference in their entireties.

### TECHNICAL FIELD

This application relates to the field of display technologies, and in particular, to a display luminance adjustment method and an electronic device.

### BACKGROUND

Display screen luminance of an electronic device is one of important factors that affect user experience. A display screen of the electronic device needs to present different display screen luminance to a user under ambient light of different intensity, to improve user experience. When the ambient light is stronger, the display screen needs to present higher luminance. When the ambient light is weaker, the display screen needs to present lower luminance.

When the ambient light changes from dark to bright, to clearly see content displayed on the display screen, the user expects the display screen to quickly become brighter. However, when the ambient light changes from bright to dark, to make eyes comfortable, the user expects the display screen to slowly change from bright to dark. Particularly, when the display screen appears comparatively dark, a sudden luminance change or a stepped luminance change on the display screen needs to be avoided. Otherwise, user experience is severely affected.

To slowly change the display screen luminance, in a conventional solution, sufficient control levels (for example, 8192 levels) are usually used to adjust backlight luminance of the display screen such that the display screen luminance slowly changes. However, for some types of display screens, when there are a small quantity of luminance control levels, for example, when there are only 1024 control levels for a display screen, when the display screen changes from bright to dark, a problem of stepped flicker still occurs in a dark region, affecting user experience.

### SUMMARY

This application provides a display luminance adjustment method and an electronic device such that overall display screen luminance changes more slowly in an adjustment process.

According to a first aspect, a display luminance adjustment method is provided. The method includes obtaining an initial luminance value of a display screen, obtaining an ambient light signal, and determining a target luminance value of the display screen based on the ambient light signal, determining a target pixel value of a to-be-displayed image based on the initial luminance value, the target luminance value, and a current pixel value of the to-be-displayed image, and presenting the to-be-displayed image on the display screen based on the target pixel value of the to-be-displayed image.

In this application, when a pixel value of the to-be-displayed image is adjusted, a luminance value of the to-be-displayed image may be separately adjusted. For example, when the pixel value of the to-be-displayed image is represented using a red, green, and blue (RGB) value, the luminance value obtained by the combined RGB value may be adjusted.

In this application, adjusting the pixel value of the to-be-displayed image may also mean adjusting both the luminance value and a chrominance value of the to-be-displayed image. Because a degree of sensitivity of human eyes to a luminance change exceeds a degree of sensitivity of the human eyes to a chrominance change, a chrominance change of the to-be-displayed image exerts little visual impact on the human eyes. For example, when the pixel value of the to-be-displayed image in this application is represented using an RGB value, determining a target pixel value of a to-be-displayed image may be adjusting a current RGB value of the to-be-displayed image to obtain an adjusted RGB value of the to-be-displayed image. In addition, adjusting an RGB value is equivalent to adjusting both the luminance value and the chrominance value of the to-be-displayed image.

The display luminance adjustment method in this application may be performed by an electronic device having a display function. The electronic device may be a mobile phone, a computer (for example, a personal computer or a tablet computer), a personal digital assistant (PDA), a wearable device, or the like.

The to-be-displayed image may be a screen saver, an operation interface, a picture, a web page, a video, or the like displayed by the electronic device.

The ambient light signal may be used to indicate intensity of light around the display screen.

Strength of the ambient light signal may be in positive correlation to the intensity of the light around the display screen. Larger intensity of the light around the display screen indicates larger strength of the ambient light signal. Smaller intensity of the light around the display screen indicates smaller strength of the ambient light signal.

In this application, an ambient light sensor of the electronic device may be used to sense the intensity of the light around the display screen, and a control chip inside the electronic device may be used to adjust backlight luminance of the display screen. In this way, power consumption of the electronic device is reduced. In a mobile application such as a mobile phone, a notebook computer, or a tablet computer, a percentage of power consumed by a display screen in total battery power is a comparatively large. In this case, working duration of a battery can be maximized using an ambient light sensor. In addition, the ambient light sensor helps a display provide a soft picture. When ambient luminance is higher, a liquid-crystal display (LCD) using an ambient light sensor is automatically adjusted to higher luminance. When an external environment is darker, the display is adjusted to lower luminance.

The ambient light sensor mainly includes a photosensitive element (for example, a photoresistor, a photosensitive diode, a phototriode, a phototransistor, or a silicon photocell), a signal adjustment module, and an analog-to-digital converter. When light shines on the photosensitive element, the photosensitive element generates an analog signal (a current signal or a voltage signal). The signal adjustment module may perform processing such as amplification and filtering on the analog signal. Then the analog-to-digital converter may be used to perform analog-to-digital conversion on a final analog signal obtained through processing, to obtain a digital signal. Digital signals of different values correspond to ambient light of different intensity. Therefore, after the ambient light sensor transmits the finally obtained digital signal to the control chip inside the device, the control chip may adjust display screen luminance based on intensity of external light.

In this application, when the display screen luminance is adjusted, a luminance level quantity adjustment range may be increased by adjusting the pixel value of the to-be-displayed image such that an entire luminance adjustment range of the display screen can be increased. In this way, overall display screen luminance changes more gently in an adjustment process, thereby improving user experience.

Further, it is assumed that there are 1024 dimming levels for the display screen, and there are 256 levels for a pixel value of the to-be-displayed image. In this case, both the display screen luminance and the pixel value of the to-be-displayed image are adjusted such that there can be 1024×256 options for luminance adjustment. In this way, a luminance adjustment range is increased. In addition, compared with directly adjusting a level quantity of the display screen luminance, a manner of adjusting the luminance by adjusting a pixel value of the image can make a user perceive a gentler luminance change.

It should be understood that, in this application, a luminance change value between adjacent images is less than a luminance change value corresponding to adjacent luminance levels of the display screen.

For example, a total of 10 frames of images are displayed between a first luminance level and a second luminance level. In this case, a luminance change value between adjacent images in the 10 frames of images is less than a luminance change value obtained when the display screen changes from the first luminance level to the second luminance level.

In a possible implementation, the initial luminance value is greater than the target luminance value.

In another possible implementation, the initial luminance value is less than the target luminance value.

That is, in the display luminance adjustment method in this application, the display screen luminance may be adjusted to a larger value or a smaller value.

In a possible implementation, the initial luminance value is a maximum luminance value or a minimum luminance value of the display screen. In this case, presented luminance cannot be adjusted by adjusting the display screen luminance, and only the pixel value of the to-be-displayed image is adjusted. When the initial luminance value is the maximum luminance value or the minimum luminance value of the display screen, the target luminance value of the display screen is equal to the initial luminance value of the display screen. It may be understood that the foregoing case in which the target luminance value of the display screen is equal to the initial luminance value of the display screen is mainly applicable to a case in which luminance that needs to be adjusted exceeds a physical parameter of the display screen. For example, when the initial luminance value of the display screen is the minimum luminance value of the display screen, if the display screen luminance needs to be decreased based on the ambient light, the target luminance value is equal to the initial luminance value, and perceived luminance is decreased only by adjusting the pixel value of the to-be-displayed image, or if the display screen luminance needs to be increased based on the ambient light, the target luminance value may be greater than the initial luminance value, and perceived luminance may be increased by adjusting the pixel value of the to-be-displayed image and the display screen luminance.

In a possible implementation, a dimming level quantity corresponding to the initial luminance value is adjacent to a dimming level quantity corresponding to the target luminance value.

Further, that a dimming level quantity corresponding to the initial luminance value is adjacent to a dimming level quantity corresponding to the target luminance value may include that the dimming level quantity corresponding to the initial luminance value is greater than the dimming level quantity corresponding to the target luminance value, and a dimming level quantity corresponding to the initial luminance value is less than a dimming level quantity corresponding to the target luminance value.

For example, a dimming level quantity corresponding to the initial luminance value is A (A is an integer greater than or equal to 0), and a dimming level quantity corresponding to the target luminance value is A+1 or A−1. When the display screen luminance is adjusted, the display screen luminance can be adjusted from the initial luminance value to the target luminance value by adjusting light once.

In a possible implementation, a dimming level quantity corresponding to the initial luminance value is not adjacent to a dimming level quantity corresponding to the target luminance value.

For example, the dimming level quantity corresponding to the initial luminance value is A, and the dimming level quantity corresponding to the target luminance value is A+N or A−N. In this case, when the display screen luminance is adjusted, the display screen luminance can be adjusted from the initial luminance value to the target luminance value by adjusting light N times, where A is an integer greater than or equal to 0, and N is an integer greater than 1.

In a possible implementation, presenting the to-be-displayed image on the display screen based on the target pixel value of the to-be-displayed image includes controlling the to-be-displayed image to gradually change from the current pixel value to the target pixel value. A change rate at which the to-be-displayed image gradually changes from the current pixel value to the target pixel value is in direct proportion to a change rate at which the initial luminance value changes to the target luminance value in a unit time.

In this application, the to-be-displayed image slowly changes from the current pixel value to the target pixel value with reference to the luminance change rate of the display screen such that a change of the overall display screen luminance matches a luminance adjustment speed of the display screen when an entire luminance adjustment range of the display screen is increased. In this way, flicker phenomena occurring in an adjustment process can be reduced or avoided, and visual experience of the user can be further improved.

In a possible implementation, obtaining a target pixel value of a to-be-displayed image based on the initial luminance value, the target luminance value, and a current pixel value of the to-be-displayed image includes determining a pixel adjustment coefficient of the to-be-displayed image based on the initial luminance value and the target luminance value, and obtaining the target pixel value of the to-be-displayed image based on the pixel adjustment coefficient and the current pixel value of the to-be-displayed image.

In a possible implementation, obtaining the target pixel value of the to-be-displayed image based on the pixel adjustment coefficient and the current pixel value of the to-be-displayed image includes determining a product of the pixel adjustment coefficient and the current pixel value of the to-be-displayed image as the target pixel value of the to-be-displayed image.

In a possible implementation, determining a target pixel value of a to-be-displayed image based on the initial luminance value, the target luminance value, and a current pixel value of the to-be-displayed image includes adjusting a preset initial pixel adjustment coefficient based on the initial luminance value and the target luminance value, to obtain a pixel adjustment coefficient of the to-be-displayed image, where the pixel adjustment coefficient of the to-be-displayed image is greater than or equal to the initial pixel adjustment coefficient, and obtaining the target pixel value of the to-be-displayed image based on the pixel adjustment coefficient of the to-be-displayed image and the current pixel value of the to-be-displayed image.

Optionally, the initial pixel adjustment coefficient may be a lower limit value of the pixel adjustment coefficient of the to-be-displayed image, and the pixel adjustment coefficient of the to-be-displayed image is greater than or equal to the initial pixel adjustment coefficient. When the initial pixel adjustment coefficient is adjusted, a value (where the value is greater than or equal to 0) may be added to the initial pixel adjustment coefficient such that the pixel adjustment coefficient of the to-be-displayed image can be greater than or equal to the initial pixel adjustment coefficient.

Further, when the initial pixel adjustment coefficient is adjusted, the initial pixel adjustment coefficient may be adjusted at least once using a specific coefficient step value such that the pixel adjustment coefficient of the to-be-displayed image is greater than or equal to the initial pixel adjustment coefficient.

It should be understood that the initial pixel adjustment coefficient may be determined based on the initial luminance value and the target luminance value. For example, the initial pixel adjustment coefficient is determined as 0.90 based on the initial luminance value and the target luminance value. In this case, 0.90 may be adjusted to obtain the pixel adjustment coefficient of the to-be-displayed image such that the pixel adjustment coefficient of the to-be-displayed image is greater than or equal to 0.90.

In a possible implementation, determining a target pixel value of a to-be-displayed image based on the initial luminance value, the target luminance value, and a current pixel value of the to-be-displayed image includes determining an initial pixel adjustment coefficient, adjusting the initial pixel adjustment coefficient to obtain a pixel adjustment coefficient of the to-be-displayed image, where the pixel adjustment coefficient of the to-be-displayed image is greater than or equal to a first pixel adjustment coefficient, and the first pixel adjustment coefficient is determined based on the initial luminance value and the target luminance value, and obtaining the target pixel value of the to-be-displayed image based on the pixel adjustment coefficient and the current pixel value of the to-be-displayed image.

Optionally, the initial pixel adjustment coefficient may be 1 or another preset value.

Optionally, when the initial pixel adjustment coefficient is adjusted, a value may be subtracted from the initial pixel adjustment coefficient such that the pixel adjustment coefficient of the to-be-displayed image can be greater than or equal to the first pixel adjustment coefficient.

Further, when the initial pixel adjustment coefficient is adjusted, the initial pixel adjustment coefficient may be adjusted at least once using a coefficient step value such that the pixel adjustment coefficient of the to-be-displayed image is greater than or equal to the first pixel adjustment coefficient.

For example, the initial pixel adjustment coefficient is 1, the coefficient step value is 0.02, and the initial pixel adjustment coefficient is adjusted 10 times using the coefficient step value 0.02, to obtain the pixel adjustment coefficient of the to-be-displayed image as 0.80.

It should be understood that, in this application, the initial pixel adjustment coefficient may be a smaller value (for example, 0.90), or may be a larger value (for example, 1.0). When the initial pixel adjustment coefficient is a smaller value, the initial pixel adjustment coefficient may be directly adjusted such that an obtained pixel adjustment coefficient of the to-be-displayed image is greater than or equal to the initial pixel adjustment coefficient. When the initial pixel adjustment coefficient is a larger value, the initial pixel adjustment coefficient may be directly adjusted such that an obtained pixel adjustment coefficient of the to-be-displayed image is greater than or equal to the first pixel adjustment coefficient (where the first pixel adjustment coefficient is equivalent to the lower limit value of the pixel adjustment coefficient of the to-be-displayed image).

In a possible implementation, obtaining a target pixel value of a to-be-displayed image based on the initial luminance value, the target luminance value, and a current pixel value of the to-be-displayed image includes determining a reference luminance value of the to-be-displayed image based on the initial luminance value, where the reference luminance value is greater than or equal to the initial luminance value, and the reference luminance value is less than or equal to the target luminance value, or the reference luminance value is less than or equal to the initial luminance value, and the reference luminance value is greater than or equal to the target luminance value, obtaining a pixel adjustment coefficient of the to-be-displayed image based on a ratio of the reference luminance value to the initial luminance value, or obtaining a pixel adjustment coefficient of the to-be-displayed image based on a ratio of the reference luminance value to the target luminance value, and obtaining the target pixel value of the to-be-displayed image based on the pixel adjustment coefficient and the current pixel value of the to-be-displayed image.

In this application, the reference luminance value is limited between the initial luminance value and the target luminance value such that a pixel adjustment coefficient finally calculated based on the reference luminance value is not excessively large or excessively small.

In a possible implementation, the to-be-displayed image includes N frames of images. Adjusting an initial luminance value to obtain a reference luminance value of the to-be-displayed image includes adjusting the initial pixel adjustment coefficient to obtain a pixel adjustment coefficient of each of the N frames of images. The pixel adjustment coefficients of the N frames of images are in ascending order or in descending order, and a pixel adjustment coefficient of any frame of image in the N frames of images is greater than or equal to the first pixel adjustment coefficient, where N is an integer greater than or equal to 2.

Further, when the to-be-displayed image includes N frames of images, the initial pixel adjustment coefficient may be adjusted using a preset coefficient step value, to obtain a pixel adjustment coefficient of each frame of image.

For example, the initial pixel adjustment coefficient is 1, the coefficient step value is 0.02, and the to-be-displayed image includes a total of five frames of images. In this case, the initial pixel adjustment coefficient may be adjusted five times using the coefficient step value 0.02. In this way, pixel adjustment coefficients of the five frames of images are respectively obtained as 0.98, 0.96, 0.94, 0.92, and 0.90.

Different pixel adjustment coefficients are set for the N frames of images such that the pixel values of the to-be-displayed image can change gently, thereby improving user experience.

In a possible implementation, when the target luminance value is less than the initial luminance value, a pixel adjustment coefficient of an image frame (i+1) in the N frames of images is less than a pixel adjustment coefficient of an image frame i in the N frames of images.

When the target luminance value is less than the initial luminance value, the display screen luminance gradually decreases, and the pixel adjustment coefficients of the N frames of images displayed in this case are in descending order. Therefore, differences of adjusted pixel values of the N frames of images relative to the original pixel value are in ascending order. In this way, the pixel values slowly decrease, and user experience is ensured.

In a possible implementation, when the target luminance value is greater than the initial luminance value, a pixel adjustment coefficient of an image frame (i+1) in the N frames of images is greater than a pixel adjustment coefficient of an image frame i in the N frames of images.

When the target luminance value is greater than the initial luminance value, the display screen luminance gradually increases, and pixel adjustment coefficients of the N frames of images displayed in this case are in ascending order. Therefore, differences of adjusted pixel values of the N frames of images relative to the original pixel value are in descending order. In this way, the pixel values slowly increase, and user experience is ensured.

In a possible implementation, determining a target pixel value of a to-be-displayed image based on the initial luminance value, the target luminance value, and a current pixel value of the to-be-displayed image includes determining a reference luminance value of the to-be-displayed image based on the initial luminance value, where the reference luminance value is greater than or equal to the initial luminance value, and the reference luminance value is less than or equal to the target luminance value, or the reference luminance value is less than or equal to the initial luminance value, and the reference luminance value is greater than or equal to the target luminance value, obtaining a pixel adjustment coefficient of the to-be-displayed image based on a ratio of the reference luminance value to the initial luminance value, or obtaining a pixel adjustment coefficient of the to-be-displayed image based on a ratio of the reference luminance value to the target luminance value, and obtaining the target pixel value of the to-be-displayed image based on the pixel adjustment coefficient and the current pixel value of the to-be-displayed image.

In a possible implementation, when the to-be-displayed image includes N (where N is an integer greater than 1) frames of images, in a process of determining the reference luminance value of the to-be-displayed image based on the initial luminance value, the initial luminance value may be adjusted a plurality of times, to obtain a reference luminance value of each of the N frames of images.

When the reference luminance value of the to-be-displayed image is determined based on the initial luminance value, if the target luminance value is greater than the initial luminance value, the reference luminance values may be in ascending order, and none of the reference luminance values exceeds the target luminance value, or if the target luminance value is less than the initial luminance value, the reference luminance values may be in descending order, and none of the reference luminance values is less than the target luminance value.

In addition, the N frames of images may be images to be displayed within one luminance adjustment period. Further, the N frames of images are images to be displayed within two adjacent luminance adjustment periods.

In this application, because the reference luminance values of the N frames of images gradually change, pixel adjustment coefficients of the N frames of images that are obtained using ratios of reference luminance values of all the N frames of image to the initial luminance value or the target luminance value are also in ascending order or in descending order. In this way, adjustment amplitudes of the pixel values of the N frames of images are in ascending order such that finally presented overall luminance changes comparatively gently.

Optionally, when the initial luminance value is adjusted, a luminance adjustment step value may be first determined, and then the initial luminance value is adjusted based on the luminance adjustment step value in order to obtain the reference luminance value of the to-be-displayed image.

The luminance adjustment step value may be a preset value, or may be determined based on a luminance change rate of the display screen. The luminance adjustment step value is in positive correlation to the luminance change rate of the display screen. That is, a larger luminance change rate of the display screen indicates a larger luminance adjustment step value, and a smaller luminance change rate of the display screen indicates a smaller luminance adjustment step value.

Optionally, determining reference luminance of each of the N frames of images based on the initial luminance value and the target luminance value further includes determining a luminance change rate of the display screen based on the initial luminance value and the target luminance value, and determining the reference luminance of each frame of image based on the initial luminance value and the luminance change rate of the display screen.

Further, the reference luminance of each frame of image may be calculated based on the following formula:

ref_lum[i]=start_lum−i*step_lum.

ref_lum [i] is a reference luminance value of an image frame i, start_lum is the initial luminance value, step_lum is the luminance adjustment step value, and i is a positive integer less than or equal to N.

After the reference luminance of each frame of image is obtained, a pixel adjustment coefficient of each frame of image may be calculated based on the following formula:

$$adj\_coef [ i ] = {( \frac{ref\_lum [ i ]}{start\_lum} )}^{1 / r} .$$

adj_coef [i] is a pixel adjustment coefficient of the image frame i, start_lum is the initial luminance value, ref_lum [i] is a reference luminance value of the image frame i, i is an integer greater than or equal to 0, r is a constant, and a value of r ranges from 2.2 to 2.4, and in an embodiment, the value of r is 2.2 or 2.4.

In a possible implementation, after presenting the to-be-displayed image on the display screen, the method further includes adjusting the display screen luminance, where an adjusted luminance value of the display screen is the target luminance value.

In this application, when the display screen is to be adjusted from the initial luminance value to the target luminance value, overall luminance of the electronic device can slowly change by presenting an adjusted pixel value of the to-be-displayed image. In this way, luminance flicker of the electronic device in a luminance adjustment process is reduced or avoided.

In a possible implementation, before presenting the to-be-displayed image on the display screen, the method further includes adjusting the display screen luminance, where an adjusted luminance value of the display screen is the target luminance value.

In a possible implementation, before determining a target pixel value of a to-be-displayed image based on the initial luminance value, the target luminance value, and a current pixel value of the to-be-displayed image, the method further includes determining a value relationship between the initial luminance value and preset luminance. Determining a target pixel value of a to-be-displayed image based on the initial luminance value, the target luminance value, and a current pixel value of the to-be-displayed image includes when the initial luminance value is less than the preset luminance, determining the target pixel value of the to-be-displayed image based on the initial luminance value, the target luminance value, and the current pixel value of the to-be-displayed image.

That is, in this application, the pixel value of the to-be-displayed image may be adjusted based on the initial luminance value and the target luminance value only when the initial luminance value is less than the preset luminance.

In a possible implementation, the target luminance value is lowest physical luminance that can be achieved by the display screen.

In this application, after the display screen luminance reaches the lowest physical luminance, overall luminance of the electronic device may be further reduced by adjusting a pixel value of an image such that the electronic device can achieve lower luminance. In this way, better experience is brought to a user in some darker environments.

According to a second aspect, an electronic device is provided. The electronic device includes an obtaining module, a processing module, and a presentation module. The obtaining module is configured to obtain an initial luminance value of a display screen and an ambient light signal. The processing module is configured to determine a target luminance value of the display screen based on the ambient light signal. The processing module is further configured to obtain a target pixel value of a to-be-displayed image based on the initial luminance value, the target luminance value, and a current pixel value of the to-be-displayed image. The presentation module is configured to present the to-be-displayed image based on the target pixel value of the to-be-displayed image.

In a possible implementation, the processing module is further configured to control the to-be-displayed image to gradually change from the current pixel value to the target pixel value. A change rate at which the to-be-displayed image gradually changes from the current pixel value to the target pixel value is in direct proportion to a change rate at which the initial luminance value changes to the target luminance value in a unit time.

In a possible implementation, the processing module is further configured to determine a pixel adjustment coefficient of the to-be-displayed image based on the initial luminance value and the target luminance value, and obtain the target pixel value of the to-be-displayed image based on the pixel adjustment coefficient and the current pixel value of the to-be-displayed image.

In a possible implementation, the processing module is further configured to determine a product of the pixel adjustment coefficient and the current pixel value of the to-be-displayed image as the target pixel value of the to-be-displayed image.

In a possible implementation, the processing module is further configured to adjust a preset initial pixel adjustment coefficient based on the initial luminance value and the target luminance value, to obtain a pixel adjustment coefficient of the to-be-displayed image, where the pixel adjustment coefficient of the to-be-displayed image is greater than or equal to the initial pixel adjustment coefficient, and obtain the target pixel value of the to-be-displayed image based on the pixel adjustment coefficient of the to-be-displayed image and the current pixel value of the to-be-displayed image.

Optionally, a product of the pixel adjustment coefficient and a current pixel value of the to-be-displayed image is determined as the target pixel value of the to-be-displayed image.

In a possible implementation, the to-be-displayed image includes N frames of images, where N is a positive integer not less than 2. The processing module is further configured to adjust the initial pixel adjustment coefficient to obtain a pixel adjustment coefficient of each of the N frames of images, where the pixel adjustment coefficients of the N frames of images are in ascending order or in descending order.

In a possible implementation, the processing module is further configured to determine a reference luminance value of the to-be-displayed image based on the initial luminance value, where the reference luminance value is greater than or equal to the initial luminance value, and the reference luminance value is less than or equal to the target luminance value, or the reference luminance value is less than or equal to the initial luminance value, and the reference luminance value is greater than or equal to the target luminance value, obtain a pixel adjustment coefficient of the to-be-displayed image based on a ratio of the reference luminance value to the initial luminance value, or obtain a pixel adjustment coefficient of the to-be-displayed image based on a ratio of the reference luminance value to the target luminance value, and obtain the target pixel value of the to-be-displayed image based on the pixel adjustment coefficient and the current pixel value of the to-be-displayed image.

In a possible implementation, the to-be-displayed image includes N frames of images, where N is a positive integer not less than 2. The processing module is further configured to adjust the initial luminance value to obtain a reference luminance value of each of the N frames of images.

In a possible implementation, the processing module is further configured to determine a luminance adjustment step value, and adjust the initial luminance value based on the luminance adjustment step value, to obtain the reference luminance value of the to-be-displayed image.

In a possible implementation, the processing module is further configured to determine the luminance adjustment step value based on a luminance change rate of the display screen, where the luminance adjustment step value is in positive correlation to the luminance change rate of the display screen.

In a possible implementation, the to-be-displayed image includes N frames of images, where N is a positive integer not less than 2. The processing module is further configured to determine a reference luminance value of an image frame i based on a formula ref_lum [i]=start_lum−i*step_lum, where ref_lum [i] is the reference luminance value of the image frame i, start_lum is the initial luminance value, step_lum is the luminance adjustment step value, and i is a positive integer less than or equal to N.

In a possible implementation, before the display screen presents the to-be-displayed image, the processing module is further configured to adjust display screen luminance, where an adjusted luminance value of the display screen is used as the target luminance value.

According to a third aspect, an electronic device is provided. The electronic device includes an obtaining unit, a processor and a display screen. The obtaining unit is configured to obtain an initial luminance value of a display screen and an ambient light signal. The processor is configured to determine a target luminance value of the display screen based on the ambient light signal, and obtain a target pixel value of a to-be-displayed image based on the initial luminance value, the target luminance value, and a current pixel value of the to-be-displayed image. The display screen is configured to present the to-be-displayed image on the display screen based on the target pixel value of the to-be-displayed image.

It should be understood that the electronic device in the second aspect and the third aspect may perform the display luminance adjustment method in the first aspect. Limitation and extension of each step in the first aspect are also applicable to the second aspect and the third aspect, and analysis of a beneficial effect in the first aspect is also applicable to the second aspect and the third aspect.

### BRIEF DESCRIPTION OF DRAWINGS

FIG. 1 is a schematic flowchart of a display luminance adjustment method according to an embodiment of this application.

FIG. 2 is a schematic diagram of several manners of determining a target pixel value of a to-be-displayed image.

FIG. 3 is a flowchart of a display luminance adjustment method according to an embodiment of this application.

FIG. 4A and FIG. 4B are a flowchart of a display luminance adjustment method according to an embodiment of this application.

FIG. 5 is a flowchart of a display luminance adjustment method according to an embodiment of this application.

FIG. 6 is a flowchart of a display luminance adjustment method according to an embodiment of this application.

FIG. 7 is a schematic block diagram of an electronic device according to an embodiment of this application.

FIG. 8 is a schematic block diagram of an electronic device according to an embodiment of this application.

### DESCRIPTION OF EMBODIMENTS

The following describes technical solutions of this application with reference to accompanying drawings.

To better understand the display luminance adjustment method in the embodiments of this application, the following first briefly describes some basic features related to luminance adjustment of a display screen.

Generally, there are a plurality of dimming levels (luminance control levels) for the display screen. When the display screen is at different dimming levels, the display screen has different luminance. When a display luminance value of the display screen needs to be adjusted, a dimming level of the display screen may be adjusted by controlling a drive current or a drive voltage of the display screen in order to adjust display screen luminance.

The display screen of the electronic device may also be referred to as a screen of the electronic device, and the display screen luminance refers to strength of light emitted by the display screen.

The display luminance of the electronic device may be understood as overall luminance presented after the display screen luminance of the electronic device and luminance of an image displayed on the display screen are merged. A value or a change speed of the overall luminance finally affects user experience.

Generally, a larger quantity of dimming levels for the display screen indicates a smaller minimum amplitude of a luminance change of the display screen and a slower change in display screen luminance. There is a larger quantity of dimming levels for an LCD screen, and generally, 13 bits (8192 levels) can be reached. However, there are a smaller quantity of control levels for an active-matrix organic light emitting diode (AMOLED) display screen, and generally, there are only 10 bits (1024 levels), and there are only eight bits (256 levels) for control levels of some AMOLED display screens. Therefore, when luminance of the LCD screen is adjusted, a stepped flicker may occur. Particularly, for an AMOLED display screen, because of a smaller quantity of dimming levels, a more obvious stepped flicker may occur during luminance adjustment.

The display luminance adjustment method in the embodiments of this application is applicable to the LCD screen, the AMOLED display screen, and another type of display screen. This is not limited in this application.

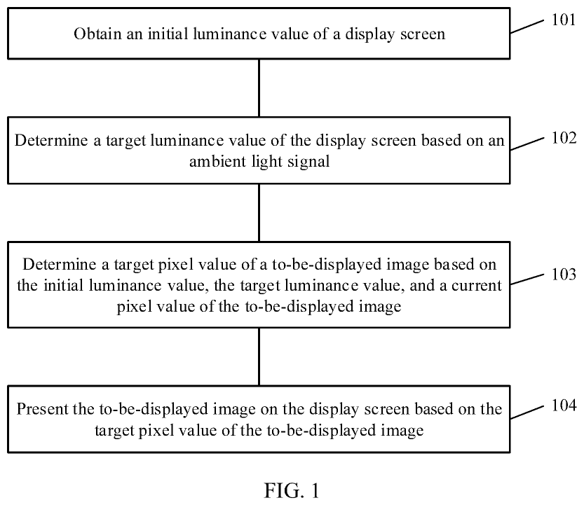

FIG. 1 is a schematic flowchart of a display luminance adjustment method according to an embodiment of this application. The display luminance adjustment method in this embodiment of this application may be performed by an electronic device. Further, the display luminance adjustment method in this embodiment of this application may be performed by a controller or a processor of the electronic device.

In addition, when the display luminance adjustment method in this embodiment of this application is applicable to the electronic device, display luminance adjusted in this embodiment of this application may be overall luminance presented on a display screen of the electronic device. The overall luminance may be luminance obtained by merging display screen luminance and luminance that is presented by an image displayed on the display screen.

The electronic device may be a mobile phone, a personal computer, a tablet computer, a PDA, a wearable device, or the like.

The method shown in FIG. 1 includes step 101 to step 104. The following describes step 101 to step 104 in detail.

101. Obtain an initial luminance value of a display screen.

The initial luminance value of the display screen may be a luminance value of the display screen that is obtained when display screen luminance starts to be adjusted. In addition, the initial luminance value may alternatively be a specific luminance value obtained in a process of adjusting the display screen luminance.

102. Determine a target luminance value of the display screen based on an ambient light signal.

It should be understood that the ambient light signal may be obtained before step 102 is performed. Intensity of external ambient light may be obtained using a light sensor, to obtain optical signal. Strength of the ambient light signal may be in positive correlation to the intensity of the external ambient light. Larger intensity of the external ambient light indicates a stronger ambient light signal.

Further, the target luminance value is in positive correlation to the strength of the ambient light signal. Further, the larger intensity of the external ambient light indicates the stronger ambient light signal and a larger target luminance value of the display screen that is determined based on the ambient light signal.

The target luminance value may be greater than or less than the initial luminance value of the display screen.

Further, when the external ambient light is stronger, the display screen needs to be adjusted from a smaller luminance value to a larger luminance value such that a user can clearly see content displayed on the display screen. In this case, the target luminance value is greater than the initial luminance value. When the external ambient light is weaker, the display screen needs to be adjusted from a larger luminance value to a smaller luminance value, to make the eyes of the user comfortable. In this case, the target luminance value is less than the initial luminance value.

To determine the target luminance value of the display screen based on the ambient light signal, the processor or the controller of the electronic device may calculate, based on an automatic luminance control algorithm, the target luminance that matches the strength of the ambient light signal.

103. Determine a target pixel value of a to-be-displayed image based on the initial luminance value, the target luminance value, and a current pixel value of the to-be-displayed image.

The current pixel value of the to-be-displayed image may also be referred to as an original pixel value of the to-be-displayed image.

Further, in a process of determining the target pixel value of the to-be-displayed image based on the initial luminance value, the target luminance value, and the current pixel value of the to-be-displayed image, a pixel adjustment coefficient may be first determined based on the initial luminance value and the target luminance value, and then the current pixel value of the to-be-displayed image is adjusted based on the pixel adjustment coefficient to obtain the target pixel value of the to-be-displayed image. Alternatively, the current pixel value of the to-be-displayed image may be adjusted directly based on the initial luminance value and the target luminance value to obtain the target pixel value of the to-be-displayed image.

104. Present the to-be-displayed image on the display screen based on the target pixel value of the to-be-displayed image.

In this application, when the display screen luminance is adjusted, a pixel value of the to-be-displayed image can be further adjusted based on a luminance value of the display screen such that overall display luminance of the device changes comparatively slowly. In this way, user experience is improved.

In this application, when the display screen luminance is adjusted, a luminance level adjustment range may be increased by adjusting the pixel value of the to-be-displayed image such that an entire luminance adjustment range of the display screen can be increased. In this way, overall display screen luminance changes more gently in an adjustment process, thereby improving user experience.

Further, it is assumed that there are 1024 luminance adjustment levels for the display screen and 256 levels for the pixel value of the to-be-displayed image. In this case, both the display screen luminance and the pixel value of the to-be-displayed image are adjusted such that there can be 1024×256 options for luminance adjustment. In this way, a luminance adjustment range is increased. In addition, compared with a manner of directly adjusting a level quantity of the display screen luminance, a manner of adjusting the luminance by adjusting a pixel value of an image can make the user perceive a gentler luminance change.

It should be understood that, in this application, a luminance change value between adjacent images is less than a luminance change value corresponding to adjacent luminance levels of the display screen.

For example, a total of 10 frames of images are displayed between a first luminance level and a second luminance level. In this case, a luminance change value between adjacent images in the 10 frames of images is less than a luminance change value obtained when the display screen changes from the first luminance level to the second luminance level.

Optionally, in an embodiment, presenting the to-be-displayed image on the display screen based on the target pixel value of the to-be-displayed image includes controlling the to-be-displayed image to gradually change from the current pixel value to the target pixel value. A change rate at which the to-be-displayed image gradually changes from the current pixel value to the target pixel value is in direct proportion to a change rate at which the initial luminance value changes to the target luminance value in a unit time.

In this application, the to-be-displayed image slowly changes from the current pixel value to the target pixel value with reference to the luminance change rate of the display screen such that a change of the overall display screen luminance matches a luminance adjustment speed of the display screen when an entire luminance adjustment range of the display screen is increased. In this way, flicker phenomena occurring in an adjustment process can be reduced or avoided, and visual experience of the user can be further improved.

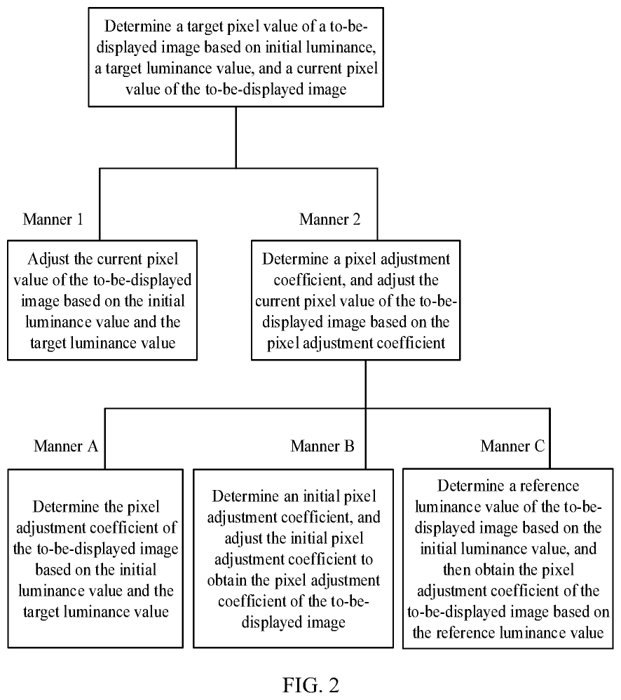

With reference to FIG. 2, the following describes in detail the determining a target pixel value of a to-be-displayed image based on the initial luminance value, the target luminance value, and a current pixel value of the to-be-displayed image.

As shown in FIG. 2, a first manner or a second implementation may be used to determine the target pixel value of the to-be-displayed image based on the initial luminance value, the target luminance value, and the current pixel value of the to-be-displayed image. The following separately describes the first manner and the second manner in detail.

In the first manner, the current pixel value of the to-be-displayed image is adjusted based on the initial luminance value and the target luminance value to obtain the target pixel value of the to-be-displayed image.

In the first manner, a pixel adjustment step value of the to-be-displayed image may be determined based on the initial luminance value and the target luminance value, and then a pixel value of the to-be-displayed image is adjusted based on the pixel adjustment step value to obtain the target pixel value of the to-be-displayed image.

For example, the initial luminance value and the target luminance value of the display screen are respectively 100 nits and 80 nits, and the to-be-displayed image includes 25 frames of images. In this case, a pixel adjustment step value can be determined as [255−255×(80/100)^{1/2.2}]/25=1. Then, the current pixel value of the to-be-displayed image minus or plus an integer multiple of 1 can be determined as the target pixel value of the to-be-displayed image.

In the second manner, a pixel adjustment coefficient is first determined, and then the current pixel value of the to-be-displayed image is adjusted based on the pixel adjustment coefficient to obtain the target pixel value of the to-be-displayed image.

In the second manner, after the pixel adjustment coefficient of the to-be-displayed image is obtained, a product of the pixel adjustment coefficient of the to-be-displayed image and the current pixel value of the to-be-displayed image can be determined as the target pixel value of the to-be-displayed image.

Further, the target pixel value of the to-be-displayed image may be calculated based on formula (1):

$$[ \begin{matrix}{R}_{out} \\ {G}_{out} \\ {B}_{out}\end{matrix} ] = [ \begin{matrix}adj\_coef & 0 & 0 \\ 0 & adj\_coef & 0 \\ 0 & 0 & adj\_coef\end{matrix} ] [ \begin{matrix}{R}_{in} \\ {G}_{in} \\ {B}_{in}\end{matrix} ] . \qquad ( 1 )$$

In formula (1), (Rₒᵤₜ, Gₒᵤₜ, Bₒᵤₜ) is the target pixel value of the to-be-displayed image, (Rᵢₙ, Bᵢₙ) is the current pixel value (an original pixel value) of the to-be-displayed image, and adj_coef is the pixel adjustment coefficient of the to-be-displayed image.

In the second manner, there are a plurality of manners for determining the pixel adjustment coefficient. As shown in FIG. 2, in the second manner, the pixel adjustment coefficient of the to-be-displayed image may be determined directly based on the initial luminance value and the target luminance value (manner A). Alternatively, an initial pixel adjustment coefficient may be first determined, and then the initial pixel adjustment coefficient is adjusted to obtain the pixel adjustment coefficient of the to-be-displayed image (manner B). Alternatively, the initial luminance value may be first adjusted, and then the pixel adjustment coefficient of the to-be-displayed image is obtained based on an obtained reference luminance value (manner C).

The following separately describes manner A, manner B, and manner C in detail.

In manner A, the pixel adjustment coefficient of the to-be-displayed image is determined based on the initial luminance value and the target luminance value.

In manner A, a reference pixel adjustment coefficient may be determined based on the initial luminance value and the target luminance value, and then a value that is greater than or equal to the reference pixel adjustment coefficient and less than 1 is selected as the pixel adjustment coefficient of the to-be-displayed image.

Further, the reference pixel adjustment coefficient may be calculated based on a ratio of the initial luminance value to the target luminance value.

Further, the reference pixel adjustment coefficient may be calculated based on formula (2):

$$adj\_coef ( ref ) = {( \frac{dst\_lum}{start\_lum} )}^{1 / r} . \qquad ( 2 )$$

In formula (2), adj_coef (ref) is the reference pixel adjustment coefficient, start_lum is the initial luminance value, dst_lum is the target luminance value, r is a constant, and a value of r ranges from 2.2 to 2.4 (including 2.2 and 2.4), and in an embodiment, the value of r is 2.2 or 2.4.

For example, the initial luminance value is 100 nits, the target luminance value is 80 nits, and r is 2.2. In this case, it may be learned, based on formula (2), that the reference pixel adjustment coefficient is 0.90. Then any value between 0.90 and 1.0 (including 0.90 and 1.0) may be selected as the pixel adjustment coefficient of the to-be-displayed image (for example, 0.94 is selected as the pixel adjustment coefficient of the to-be-displayed image).

In manner B, the initial pixel adjustment coefficient is first determined, and then the initial pixel adjustment coefficient is adjusted to obtain the pixel adjustment coefficient of the to-be-displayed image.

It should be understood that, in manner B, the initial pixel adjustment coefficient may alternatively be a preset pixel adjustment value. In this case, the preset initial pixel adjustment value may be directly adjusted to obtain the pixel adjustment coefficient of the to-be-displayed image.

Optionally, in manner B, the preset initial pixel adjustment coefficient may be adjusted based on the initial luminance value and the target luminance value to obtain the pixel adjustment coefficient of the to-be-displayed image. The pixel adjustment coefficient of the to-be-displayed image is greater than or equal to the initial pixel adjustment coefficient.

It should be understood that the initial pixel adjustment coefficient may be determined based on the initial luminance value and the target luminance value. For example, the initial pixel adjustment coefficient is determined as 0.90 based on the initial luminance value and the target luminance value. In this case, 0.90 may be adjusted to obtain the pixel adjustment coefficient of the to-be-displayed image such that the pixel adjustment coefficient of the to-be-displayed image is greater than or equal to 0.90.

Further, the initial pixel adjustment coefficient may be a lower limit value of the pixel adjustment coefficient of the to-be-displayed image, and the pixel adjustment coefficient of the to-be-displayed image is greater than or equal to the initial pixel adjustment coefficient. When the initial pixel adjustment coefficient is adjusted, a value (where the value is greater than or equal to 0) may be added to the initial pixel adjustment coefficient such that the pixel adjustment coefficient of the to-be-displayed image can be greater than or equal to the initial pixel adjustment coefficient.

In addition, when the initial pixel adjustment coefficient is adjusted, the initial pixel adjustment coefficient may be adjusted at least once using a specific coefficient step value such that the pixel adjustment coefficient of the to-be-displayed image is greater than or equal to the initial pixel adjustment coefficient.

Optionally, in manner B, an initial pixel adjustment coefficient may alternatively be first determined, and then the initial pixel adjustment coefficient is adjusted such that an adjusted pixel adjustment coefficient is between the initial pixel adjustment coefficient and a first pixel adjustment coefficient, and then the adjusted pixel adjustment coefficient is used as the pixel adjustment coefficient of the to-be-displayed image.

Further, the initial pixel adjustment coefficient may be 1, and the first pixel adjustment coefficient may be determined based on the initial luminance value and the target luminance value. Further, the first pixel adjustment coefficient may be determined based on a ratio of the initial luminance value to the target luminance value.

Further, the first pixel adjustment coefficient may be calculated based on formula (3):

$$adj\_coef ( 1 ) = {( \frac{dst\_lum}{start\_lum} )}^{1 / r} . \qquad ( 3 )$$

In formula (3), adj_coef (1) is the first pixel adjustment coefficient, start_lum is the initial luminance value, dst_lum is the target luminance value, r is a constant, and a value of r ranges from 2.2 to 2.4 (including 2.2 and 2.4), and in an embodiment, the value of r is 2.2 or 2.4.

For example, the initial luminance value is 100 nits, the target luminance value is 70 nits, and r is 2.2. In this case, it may be learned, based on formula (3), that the first pixel adjustment coefficient is 0.85. Then, the initial pixel adjustment coefficient may be adjusted provided that it is ensured that an adjusted pixel adjustment coefficient is greater than or equal to the first pixel adjustment coefficient, and the adjusted pixel adjustment coefficient is used as the pixel adjustment coefficient of the to-be-displayed image.

When the pixel adjustment coefficient of the to-be-displayed image is obtained, the initial pixel adjustment coefficient may be adjusted based on a specific coefficient step value, and the pixel adjustment coefficient obtained through the adjustment is used as the pixel adjustment coefficient of the to-be-displayed image.

Further, the pixel adjustment coefficient of the to-be-displayed image may be calculated based on formula (4):

adj_coef(dst)=adj_coef(start)−i*adj_step. (4)

In formula (4), adj_coef (dst) is the pixel adjustment coefficient of the to-be-displayed image, adj_coef (start) is the initial pixel adjustment coefficient, adj_step is the coefficient adjustment step value, and i is an integer greater than or equal to 0.

For example, adj_coef (start) is 1, the first pixel adjustment coefficient is 0.85, and adj_step is 0.01. In this case, the initial pixel adjustment coefficient may be adjusted five times (i=5) based on a step value of 0.01, and 0.95 obtained through the adjustment is used as the pixel adjustment coefficient of the to-be-displayed image.

In manner B, when the to-be-displayed image includes N frames of images, a pixel adjustment coefficient of each of the N frames of images may be obtained by adjusting the initial pixel adjustment coefficient such that the pixel adjustment coefficients of the N frames of images are in ascending order or in descending order.

For example, the initial pixel adjustment coefficient is 1, the first pixel adjustment coefficient is 0.85, and the to-be-displayed image includes five frames of images. In this case, pixel adjustment coefficients of the five frames of images may be obtained by adjusting the initial pixel adjustment coefficient. The pixel adjustment coefficients of the five frames of images may be 1.0, 0.99, 0.97, 0.96, and 0.93 sequentially. The pixel adjustment coefficients of the five frames of images are between the initial pixel adjustment coefficient and the first pixel adjustment coefficient, and the pixel adjustment coefficients of the five frames of images are in descending order. In addition, the pixel adjustment coefficients of the five frames of images are in descending order with unequal differences between adjacent coefficients.

Certainly, pixel adjustment coefficients in descending order with equal differences between adjacent coefficients may alternatively be obtained by adjusting the initial pixel adjustment coefficients. For example, the initial pixel adjustment coefficient is adjusted to obtain pixel adjustment coefficients of the five frames of images: 1.0, 0.99, 0.98, 0.97, and 0.96. In this case, the pixel adjustment coefficients of the five frames of images in descending order with equal differences between adjacent coefficients.

It should be understood that, in manner B, the initial pixel adjustment coefficient may be a smaller value (for example, 0.90), or may be a larger value (for example, 1.0). When the initial pixel adjustment coefficient is a smaller value, the initial pixel adjustment coefficient may be directly adjusted such that an obtained pixel adjustment coefficient of the to-be-displayed image is greater than or equal to the initial pixel adjustment coefficient. When the initial pixel adjustment coefficient is a larger value, the initial pixel adjustment coefficient may be directly adjusted such that an obtained pixel adjustment coefficient of the to-be-displayed image is greater than or equal to the first pixel adjustment coefficient (where the first pixel adjustment coefficient is equivalent to a lower limit value of the pixel adjustment coefficient of the to-be-displayed image).

In this application, in a process of obtaining the pixel adjustment coefficient of the to-be-displayed image, in addition to manner B of adjusting the initial pixel adjustment coefficient to obtain the pixel adjustment coefficient of the to-be-displayed image, manner C may be used. In manner C, the initial luminance value is adjusted to obtain the reference luminance value, and then the pixel adjustment coefficient of the to-be-displayed image is obtained based on the reference luminance value. The following describes in detail the obtaining a pixel adjustment coefficient of the to-be-displayed image in manner C.

In manner C, the reference luminance value of the to-be-displayed image is determined based on the initial luminance value, and then the pixel adjustment coefficient of the to-be-displayed image is obtained based on the obtained reference luminance value.

In manner C, the initial luminance value may be adjusted to obtain the reference luminance value of the to-be-displayed image.

Further, in manner C, the initial luminance value may be first adjusted to obtain the reference luminance value of the to-be-displayed image, and then the pixel adjustment coefficient of the to-be-displayed image is determined based on a ratio of the reference luminance value to the initial luminance value (or the target luminance value).

The reference luminance value is between the initial luminance value and the target luminance value. Further, when the initial luminance value is greater than the target luminance value, the reference luminance value is greater than or equal to the target luminance value, and the reference luminance value is less than or equal to the initial luminance value. When the initial luminance value is less than the target luminance value, the reference luminance value is greater than or equal to the initial luminance value, and the reference luminance value is less than or equal to the target luminance value.

In manner C, when the initial luminance value is adjusted to obtain the reference luminance value, a specific luminance value may be subtracted from the initial luminance value (when the initial luminance value is greater than the target luminance value), or a specific luminance value may be added to the initial luminance value (when the initial luminance value is less than the target luminance value).

When the initial luminance value is adjusted to obtain the reference luminance value, a specific luminance adjustment step value may be first determined, and then the initial luminance value is adjusted based on the luminance adjustment step value.

Further, the reference luminance value of the to-be-displayed image may be calculated based on formula (5) or formula (6):

ref_lum=start_lum−i*step_lum, and (5)

ref_lum=start_lum+i*step_lum. (6)

In formula (5) or formula (6), ref_lum is the reference luminance value of the to-be-displayed image, start_lum is the initial luminance value, step_lum is the luminance adjustment step value, and i is an integer greater than or equal to 0.

For example, when the initial luminance value is 100 nits, the target luminance value is 60 nits, the luminance adjustment step value is 2 nits, and i=5, the reference luminance value of the to-be-displayed image may be calculated as 90 nits based on formula (5).

However, when the initial luminance value is 60 nits, the target luminance value is 100 nits, the luminance adjustment step value is 2 nits, and i=5, the reference luminance value of the to-be-displayed image may be calculated as 70 nits based on formula (6).

Optionally, the luminance adjustment step value may be determined based on a luminance change rate of the display screen. When the luminance change rate of the display screen is larger, a larger luminance adjustment step value may be set. When the luminance change rate of the display screen is smaller, a smaller luminance adjustment step value may be set (the luminance adjustment step value is in positive correlation to the luminance change rate of the display screen).

In manner C, when the to-be-displayed image includes N frames of images, initial luminance values may be separately adjusted in order to obtain a reference luminance value of each of the N frames of images. The reference luminance values of the N frames of images may be in ascending order or in descending order. In addition, the reference luminance values of the N frames of images may have equal differences between adjacent reference luminance values or may have unequal differences between adjacent reference luminance values.

Further, the initial luminance value may be adjusted based on formula (7), to obtain a reference luminance value of each frame of image in the N (N is an integer greater than or equal to 2) frames of images:

ref_lum[i]=start_lum−i*step_lum. (7)

In formula (7), ref_lum [i] is a reference luminance value of an image frame i in the N frames of images, start_lum is the initial luminance value, step_lum is the luminance adjustment step value, and i is an integer less than or equal to N.

For example, when N is 5, the initial luminance value is 100 nits, the target luminance value is 60 nits, and the luminance adjustment step value is 2 nits, reference luminance values of an image frame 1 to an image frame 5 may be sequentially calculated as 98 nits, 96 nits, 94 nits, 92 nits, and 90 nits based on formula (7).

Then the pixel adjustment coefficient of each frame of image may be calculated based on formula (8):

$$adj\_coef [ i ] = {( \frac{ref\_lum [ i ]}{start\_lum} )}^{1 / r} . \qquad ( 8 )$$

In formula (8), adj_coef [i] is a pixel adjustment coefficient of the image frame i, start_lum is the initial luminance value, ref_lum [i] is the reference luminance value of the image frame i, i is an integer greater than or equal to 0, r is a constant, and the value of r ranges from 2.2 to 2.4, and in an embodiment, the value of r is 2.2 or 2.4.

For example, when the initial luminance value is 100 nits, the to-be-displayed image includes five frames of images, and reference luminance values of the five frames of images are sequentially 98 nits, 96 nits, 94 nits, 92 nits, and 90 nits, and r=2.2, pixel adjustment coefficients of the five frames of images may be sequentially obtained as 0.99, 0.98, 0.97, 0.96, and 0.95 based on formula (8).

It should be understood that, when the initial luminance value is greater than the target luminance value, the pixel adjustment coefficient of each frame of image may be calculated based on formula (8). However, when the initial luminance value is less than the target luminance value, the pixel adjustment coefficient of each frame of image may be calculated based on formula (9):

$$adj\_coef [ i ] = {( \frac{ref\_lum [ i ]}{dst\_lum} )}^{1 / r} . \qquad ( 9 )$$

In formula (9), adj_coef [i] is the pixel adjustment coefficient of the image frame i, dts_lum is the target luminance value, ref_lum [i] is the reference luminance value of the image frame i, i is an integer greater than or equal to 0, r is a constant, and the value of r ranges from 2.2 to 2.4, and in an embodiment, the value of r is 2.2 or 2.4.

It should be understood that, in this application, the pixel adjustment coefficient of the to-be-displayed image is always less than or equal to 1.

In this application, the to-be-displayed image may be displayed when a luminance value of the display screen is between the initial luminance value and the target luminance value, or may be displayed after a luminance value of the display screen reaches the target luminance value.

Optionally, in an embodiment, after the display screen presents the to-be-displayed image, the method in this embodiment of this application further includes adjusting display screen luminance, where an adjusted luminance value of the display screen is the target luminance value.

Optionally, in an embodiment, before the display screen presents the to-be-displayed image, the method in this embodiment of this application further includes adjusting display screen luminance, where an adjusted luminance value of the display screen is the target luminance value.

That is, in this application, the pixel value of the to-be-displayed image may be adjusted in a process of adjusting the display screen luminance, or may be adjusted after the display screen luminance is adjusted.

In this application, when the pixel value of the to-be-displayed image may be adjusted in the process of adjusting the display screen luminance, the overall display luminance of the electronic device can be slowly changed by adjusting the pixel value of the to-be-displayed image while the luminance value of the display screen is adjusted, improving user experience. However, if the pixel value of the to-be-displayed image is adjusted after the display screen luminance is adjusted, after the luminance value of the display screen is adjusted, the overall display luminance of the electronic device can be further reduced by adjusting the pixel value of the to-be-displayed image, and lower display luminance can be reached in some case of very weak light such that user experience can be improved.

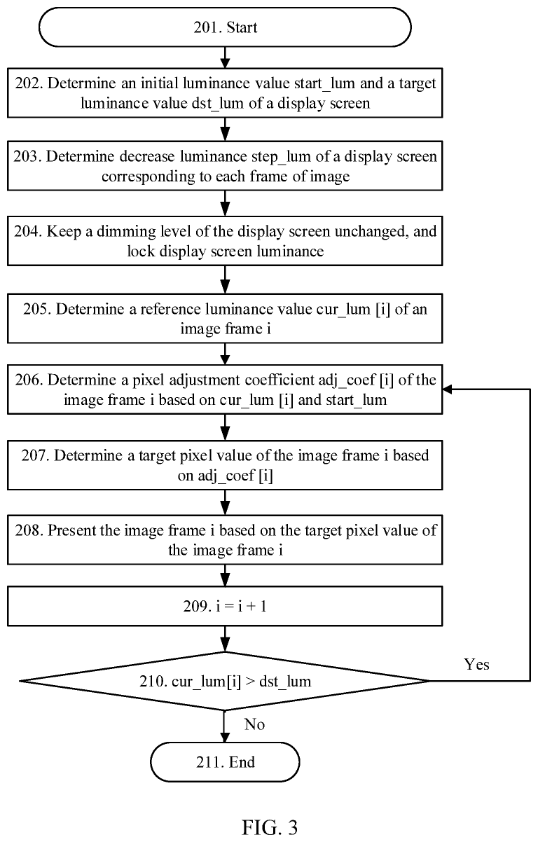

To better understand the display luminance adjustment method in this embodiment of this application, the following describes in detail display luminance adjustment methods in embodiments of this application with reference to FIG. 3 to FIG. 6.

FIG. 3 is a schematic diagram of a display luminance adjustment method according to an embodiment of this application. The method shown in FIG. 3 includes step 201 to step 211. The following describes step 201 to step 211 in detail.

201. Start.

Step 201 may be considered as a start of the display luminance adjustment method in this embodiment of this application. When ambient light around a display screen changes, the display luminance adjustment method in this embodiment of this application may start.

202. Determine an initial luminance value start_lum and a target luminance value dst_lum of the display screen.

The initial luminance and the target luminance may be display screen luminance at different luminance control levels, and a dimming level of the initial luminance may be adjacent to or may not be adjacent to a dimming level of the target luminance.

When the dimming level of the initial luminance is adjacent to the dimming level of the target luminance, the display screen may be adjusted from the initial luminance value to the target luminance value by adjusting the dimming level of the initial luminance once.

When the dimming level of the initial luminance is not adjacent to the dimming level of the target luminance, the display screen can be adjusted from the initial luminance value to the target luminance value only after the dimming level is adjusted a plurality of times.

The target luminance may be final luminance to which the display screen needs to be adjusted, or may be intermediate luminance presented in the process of adjusting the display screen luminance to the final luminance.

203. Determine decrease display screen luminance start_lum corresponding to each frame of image.

It should be understood that step_lum may be a luminance change value, of the display screen, present each time a frame of image is played based on a luminance change rate of the display screen.

Further, step_lum may be determined based on the initial luminance and the target display screen luminance.

Further, when the display screen luminance is between the initial luminance value and the target luminance value, the display screen displays a total of N frames of images. In this case, step_lum may be calculated based on formula (10):

step_lum=(start_lum−dst_lum)/N. (10)

In formula (10), step_lum is the decrease display screen luminance corresponding to each frame of image, start_lum is the initial luminance value, and dst_lum is the target luminance value.

For example, when start_lum is 820 nits, dst_lum is 800 nits, and N is 10, step_lum may be obtained as 2 nits based on formula (10).

204. Keep a dimming level of the display screen unchanged, and lock the display screen luminance.

The display screen is maintained to be at the dimming level corresponding to the initial luminance such that the display screen luminance can retain to be the initial luminance.

205. Determine reference luminance cur_lum [i] of an image frame i.

A start value of i may be 0, an image frame 0 is a frame of image presented at a moment at which the luminance value of the display screen just reaches the initial luminance value, and an image frame 1 is the image frame 1 displayed after the luminance value of the display screen reaches the initial luminance value.

Further, the reference luminance of the image frame i may be determined based on formula (11):

ref_lum[i]=start_lum−i*step_lum. (11)

In formula (11), ref_lum [i] is the reference luminance value of the image frame i in the N frames of images, start_lum is the initial luminance value, step_lum is the luminance adjustment step value, and i is an integer less than or equal to N.

206. Calculate a pixel adjustment coefficient adj_coef [i] of the image frame i based on cur_lum [i] and start_lum.

Further, adj_coef [i] may be calculated based on formula (12):

$$adj\_coef [ i ] = {( \frac{ref\_lum [ i ]}{dst\_lum} )}^{1 / r} . \qquad ( 12 )$$

In formula (12), adj_coef [i] is the pixel adjustment coefficient of the image frame i, dts_lum is the target luminance value, ref_lum [i] is the reference luminance value of the image frame i, i is an integer greater than or equal to 0, r is a constant, and the value of r ranges from 2.2 to 2.4, and in an embodiment, the value of r is 2.2 or 2.4.

For example, when start_lum is 100 nits, and step_lum=1 nit, based on formula (11), reference luminance values of the image frame 0 and the image frame 1 may be respectively obtained as cur_lum [0]=100 nits and cur_lum [1]=99 nits. The values of cur_lum [0]=100 nits and cur_lum [1] are separately substituted into formula (12) such that pixel adjustment coefficients of the image frame 0 and the image frame 1 can be respectively obtained as adj_coef [0]=1 and adj_coef [1]=0.995.

Because the pixel adjustment coefficient of the image frame 0 is 1, and the pixel adjustment coefficient of the image frame 1 is less than 1, the display screen presents the image frame 0 based on an original pixel value of the image frame 0, and presents the image frame 1 based on an adjusted target pixel value of the image frame 1.

207. Determine a target pixel value of the image frame i based on adj_coef [i] and the original pixel value of the image frame i.

Optionally, a product of adj_coef [i] and the original pixel value of the image frame i may be determined as the target pixel value of the image frame i.

208. Control the display screen to present the image frame i based on the target pixel value of the image frame i.

209. i=i+1.

Step 209 may alternatively occur directly after step 206 or step 207.

210. Determine whether cur_lum [i] is greater than dst_lum.

When cur_lum [i] is greater than dst_lum, step 206 to step 209 continue to be performed, and pixel values of other frames continue to be adjusted. When cur_lum [i] is less than or equal to dst_lum, step 211 is performed, and the process of adjusting the display luminance ends.

It should be understood that, when cur_lum [i] is greater than dst_lum, it indicates that the process of adjusting the display screen luminance does not end yet, however, when cur_lum [i] is less than or equal to dst_lum, it indicates that the process of adjusting the display screen luminance ends.

211. End.

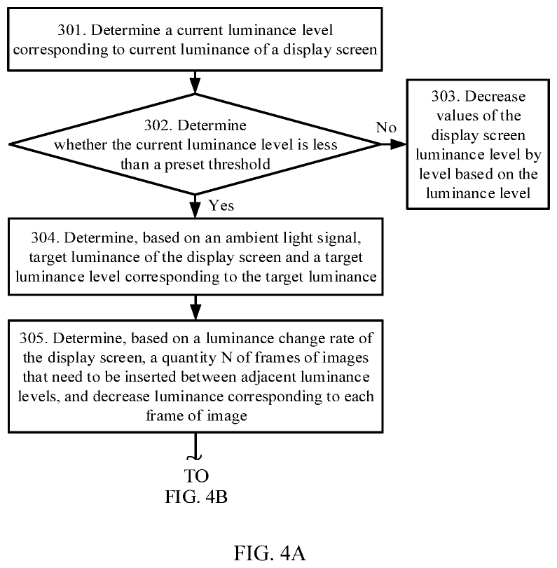

FIG. 4A and FIG. 4B are a schematic diagram of a display luminance adjustment method according to an embodiment of this application. The method shown in FIG. 4A and FIG. 4B includes step 301 to step 312. The following describes step 301 to step 312 in detail.

301. Determine a current dimming level corresponding to current display screen luminance.

For example, the current display screen luminance is 800 nits, and correspondingly, a current dimming level quantity is 900.

302. Determine whether the current dimming level quantity is less than a preset threshold.

If the current dimming level quantity is greater than or equal to the preset threshold, step 304 is performed, or if the current dimming level quantity is less than the preset threshold, step 303 is performed.

For example, the preset threshold is 800. In this case, when the current dimming level quantity is 900, and the current dimming level quantity is greater than the preset threshold, step 303 needs to be performed in order to gradually decrease the display screen luminance based on the dimming level quantity. When the current dimming level quantity is 800, the current dimming level quantity is less than the preset threshold, step 304 needs to be performed, to adjust a pixel value of a displayed image in the dimming process.

303. Decrease the display screen luminance level by level based on the dimming level quantity.

For example, the current dimming level quantity is 900. In this case, the current dimming level of the display screen is gradually decreased (by gradually decreasing a voltage value or a current value of the display screen) such that the display screen luminance is gradually decreased.

304. Determine, based on an ambient light signal, target display screen luminance and a target dimming level quantity corresponding to the target luminance.

Further, the ambient light signal may be used to indicate strength of light around the display screen, and display screen luminance that matches the light around the display screen may be calculated based on the ambient light signal. The display screen luminance that matches the ambient light around the display screen is the target display screen luminance.

305. Determine, based on a luminance change rate of the display screen, a quantity N of frames of images that need to be inserted between adjacent dimming levels, and decrease luminance corresponding to each frame of image.

Further, a larger luminance change rate of the display screen indicates that a smaller quantity of frames of images are inserted between adjacent dimming levels. A smaller luminance change rate of the display screen indicates that a larger quantity of frames of images are inserted between adjacent dimming levels.

306. Decrement the current dimming level quantity by 1.

307. Determine whether the current dimming level quantity is greater than a target dimming level quantity.

If the current dimming level quantity is less than or equal to the target dimming level quantity (for example, the current dimming level quantity is equal to the target dimming level quantity), step 308 is performed. If the current dimming level quantity is greater than the target dimming level quantity, step 309 is performed.

308. End.

If the current dimming level quantity is equal to the target dimming level quantity, the display screen luminance has been adjusted from the current luminance to the target luminance, and the dimming process ends.

309. Keep the current dimming level quantity unchanged, and determine a pixel adjustment coefficient adj_coef of a current frame frame_num of image.

An initial value of a frame number of the current frame frame_num of image is 0 (a zeroth frame), and a corresponding pixel adjustment coefficient adj_coef is 1. That is, when the current display screen luminance is just reached, a pixel adjustment coefficient of the image frame 0 is 1, the pixel value of the image frame 0 is not adjusted, but an image frame 1, an image frame 2, or the like that is subsequently displayed is adjusted.

310. Determine a target pixel value of the current frame frame_num of image based on the pixel adjustment coefficient adj_coef of the current frame frame_num of image and an original pixel value of the current frame frame_num of image.

Further, a product of adj_coef and the original pixel value of the current frame frame_num of image may be determined as the target pixel value of the current frame frame_num of image.

311. Increment frame_num of the current frame (frame_num++) by 1.

A pixel value of a subsequent frame of image can be adjusted by incrementing the frame number by 1.

312. Determine whether the current frame frame_num is less than or equal to N.

When the current frame frame_num is less than or equal to N, step 309 continues to be performed, or when the current frame frame_num is greater than N, step 306 continues to be performed.

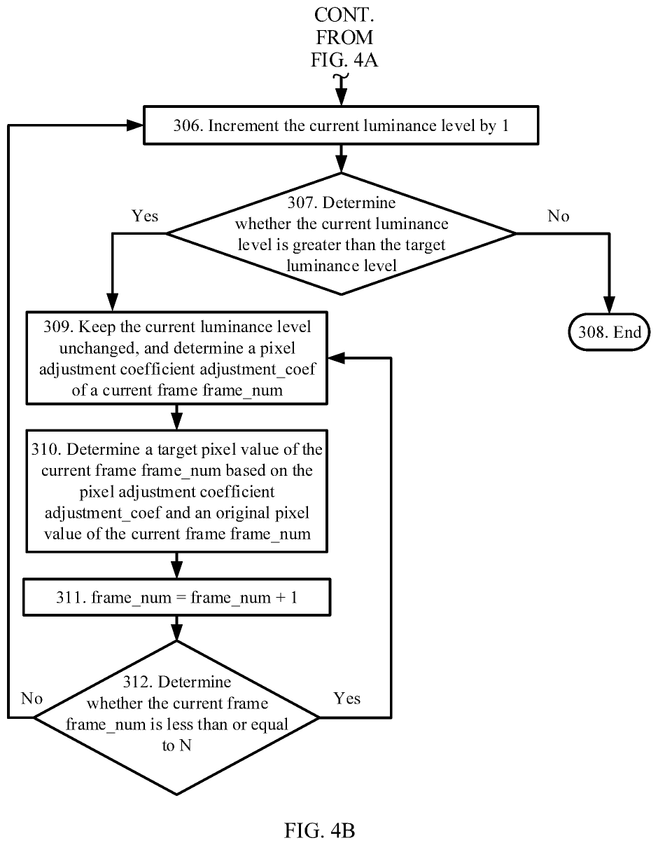

FIG. 5 is a schematic diagram of a display luminance adjustment method according to an embodiment of this application. The method shown in FIG. 5 includes step 401 to step 410. The following describes step 401 to step 410 in detail.

In the procedure shown in FIG. 5, after a dimming level of the display screen reaches a specific dimming level, a pixel value of a to-be-displayed image is first adjusted (display screen luminance remains unchanged in a process of adjusting the pixel value of the to-be-displayed image). After the pixel value is adjusted, the display screen luminance is adjusted.

401. Determine that current display screen luminance is start_lum, and a corresponding dimming level is start DBV.

The display screen luminance start_lum is a specific luminance, and the dimming level start DBV is a specific dimming level. When the display screen luminance reaches the specific luminance or a corresponding dimming level of the display screen reaches the specific dimming level, a pixel value of an image displayed on the display screen needs to be adjusted first, after the pixel value is adjusted, the display screen luminance is adjusted (that is, step 401 to step 410 are performed).

402. Determine, based on a luminance change rate of the display screen, decrease luminance step_lum corresponding to each frame of image.

The foregoing step_lum may also be referred to as a luminance decrease value corresponding to each frame of image.

step_lum may be determined based on a luminance change rate of the display screen. When the luminance change rate of the display screen is larger, a larger value of step_lum may be set. When the luminance change rate of the display screen is smaller, a smaller value of step_lum may be set (the value of step_lum is in positive correlation to the luminance change rate of the display screen).

Further, a ratio of the luminance change rate of the display screen to a quantity of frames of the image presented by the display screen in a unit time may be determined as the decrease luminance start_lum corresponding to each frame of image.

For example, the current display screen luminance start_lum is 52 nits, the target display screen luminance end_lum is 16 nits, a time required for adjusting the display screen from the current luminance to the target luminance is 12 seconds, and in a process in which the display screen is adjusted from the current luminance to the target luminance, a total of 360 frames of images are displayed (equivalent to displaying 30 frames of images per second). In this case, the decrease luminance start_lum corresponding to each frame of image is (52−16)/360=0.1 nit.

403. Keep a dimming level (start DBV) of the display screen unchanged, and lock the display screen luminance.

In step 403, the dimming level of the display screen is no longer adjusted, and the dimming level of the display screen is maintained at start DBV (a drive current or a drive voltage of the display screen is kept unchanged) such that the display screen luminance is maintained at start_lum.

404. Determine, based on step_lum, display screen luminance cur_lum corresponding to a current frame of image.

405. Determine a pixel adjustment coefficient adj_coef of the current frame of image based on cur_lum and start_lum.

For example, when start_lum is 52 nits, and step_lum is 0.1 nit, display screen luminance cur_lum[0] corresponding to an image frame 0 may be obtained as 52 nits based on formula (13). Then a pixel adjustment coefficient of the image frame 0 may be obtained as adj_coef [0]=1 based on formula (14):

$$\begin{matrix}cur\_lum [ i ] = start\_lum - i * step\_lum , and & ( 13 ) \\ adj\_coef [ i ] = {( \frac{cur\_lum [ i ]}{start\_lum} )}^{1 / 2.2} . & ( 14 )\end{matrix}$$

In formula (13) and formula (14), curium [i] represents display screen luminance corresponding to an image frame i, start_lum is a current luminance value of the display screen, step_lum is a decrease luminance value corresponding to each frame of image, adj_coef [i] is a pixel adjustment coefficient of the image frame i, and i is an integer greater than or equal to 0.

Similarly, display screen luminance cur_lum[1] corresponding to an image frame 1 may be obtained as 51.9 nits based on formula (13), and a pixel adjustment coefficient of the image frame 1 may be obtained as 0.999 based on formula (14).

It is assumed that, in the method shown in FIG. 5, pixel values of a total of 360 frames of images are adjusted. In this case, a pixel adjustment coefficient of each of the 360 frames of images may be obtained based on formula (13) and formula (14).

For example, display screen luminance corresponding to an image frame 2 to an image frame 4 may be obtained as 51.8 nits, 51.7 nits, and 51.6 nits respectively based on formula (13) and formula (14). Then pixel adjustment coefficients of the image frame 2 to the image frame 4 may be obtained as 0.998, 0.997, and 0.996 respectively based on formula (13) and formula (14).

It should be understood that, in the method shown in FIG. 5, when a quantity of frames of image whose pixel values need to be adjusted is another value, the pixel adjustment coefficient of each frame of image may alternatively be calculated based on formula (13) and formula (14).

It should be understood that, when the pixel adjustment coefficient of each frame of image is calculated based on formula (14), a quantity of decimal places that need to be retained for the pixel adjustment coefficient may be determined as required (in the foregoing example, three decimal places are retained). The quantity of decimal places that need to be retained for the pixel adjustment coefficient is not limited in this application.

406. Adjust a pixel value of the current frame of image based on the pixel adjustment coefficient adj_coef.

Further, a product of the pixel adjustment coefficient adj_coef and an original pixel value of the current frame of image may be determined as a target pixel value of the current frame of image. For example, a target pixel value of the image frame i may be calculated based on formula (15):

$$[ \begin{matrix}{R}_{out} [ i ] \\ {G}_{out} [ i ] \\ {B}_{out} [ i ]\end{matrix} ] = [ \begin{matrix}adj\_coef [ i ] & 0 & 0 \\ 0 & adj\_coef [ i ] & 0 \\ 0 & 0 & adj\_coef [ i ]\end{matrix} ] [ \begin{matrix}{R}_{in} [ i ] \\ {G}_{in} [ i ] \\ {B}_{in} [ i ]\end{matrix} ] . \qquad [ 15 ]$$

In formula (15), (Rₒᵤₜ[i], Gₒᵤₜ[i], Bₒᵤₜ[i]) is the target pixel value of the image frame i, (Rᵢₙ[i], Gᵢₙ[[i], Bᵢₙ[[i]) is a current pixel value (an original pixel value) of the image frame i, and adj_coef[i] is a pixel adjustment coefficient of the image frame i.

For example, the pixel adjustment coefficient adj_coef [1] of the image frame 1 may be obtained as 0.999 based on formula (13) and formula (14). It is assumed that an original pixel value (Rᵢₙ[1], Gᵢₙ[1], Bᵢₙ[1]) of a specific pixel of the image frame 1 is (100, 100, 100). In this case, a target pixel value (Rₒᵤₜ[1], Gₒᵤₜ[1], Bₒᵤₜ[1]) of the pixel of the image frame 1 may be obtained as (100, 100, 100) based on formula (15). It should be understood that, because the pixel adjustment coefficient of the image frame 1 is very close to 1, the target pixel value of the image frame 1 obtained after adjustment is the same as the original pixel value of the image frame 1.

407. Determine whether cur_lum is greater than or equal to the target display screen luminance end_lum.

When cur_lum is greater than or equal to end_lum, it indicates that the pixel value of the image further needs to be adjusted. In this case, step 404 needs to be performed.

When cur_lum is less than end_lum, it indicates that adjustment of the pixel value of the image is completed. The display screen luminance may be adjusted subsequently. Then step 408 continues to be performed.

408. Keep the pixel adjustment coefficient adj_coef unchanged, and gradually decrease a current dimming level cur_dbv of display screen.

The pixel adjustment coefficient adj_coef is kept unchanged, then a pixel value of a subsequently displayed image is adjusted using the pixel adjustment coefficient, and the to-be-displayed image is presented based on an adjusted pixel value. In addition, when the image is displayed, a current dimming level quantity of the display screen gradually decreases.

409. Determine whether cur_dbv is greater than a target dimming level quantity dst_dbv.

When cur_dbv is greater than dst_dbv, the dimming level quantity of the display screen needs to be further reduced. In this case, step 408 needs to be performed. When cur_dbv is less than or equal to dst_dbv, step 410 is performed, and the process of adjusting the display luminance ends.

410. End.

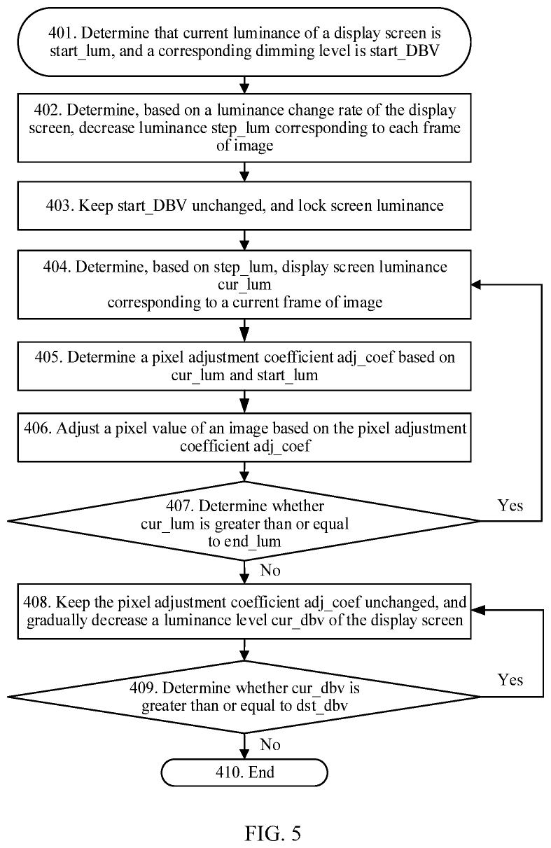

FIG. 6 is a schematic diagram of a display luminance adjustment method according to an embodiment of this application. The method shown in FIG. 6 includes step 501 to step 508. The following describes step 501 to step 508 in detail. In the method shown in FIG. 6, a minimum physical luminance of a display screen can be broken through by adjusting a pixel value of a to-be-displayed image, to implement a smaller display luminance. In this way, the display screen is not dazzling in a very dark environment. For example, a white display luminance present on some display screens is 4 nits when the display screens are darkest. In some specific environments, for example, in a dark room, the display screen is still dazzling in the case of 4 nits. The white display luminance present on the display screens can reach 2 nits by adjusting pixel values of images.

501. The display screen achieves physical lowest luminance screen_dark_lum.

The display screen may be adjusted to a smallest dimming level by controlling the display screen. In this case, the display screen achieves the lowest luminance. Further, a voltage or a current of the display screen may be adjusted to a minimum voltage or a minimum current of the display screen such that the display screen achieves the physical lowest luminance.

502. Determine, based on a luminance change rate of the display screen, decrease luminance start_lum corresponding to each frame of image.

step_lum may be determined based on the luminance change rate of the display screen. When the luminance change rate of the display screen is larger, a larger value of step_lum may be set. When the luminance change rate of the display screen is smaller, a smaller value of step_lum may be set.

503. Determine, based on step_lum, display screen luminance cur_lum corresponding to a current frame of image.

Further, display screen luminance corresponding to an image frame i may be determined based on formula (16):

cur_lum[i]=start_lum−i*step_lum. (16)

In formula (16), cur_lum [i] is the display screen luminance corresponding to the image frame i, start_lum is an initial luminance value, step_lum is decrease luminance corresponding to each frame of image, and i is an integer less than or equal to N.

504. Determine a pixel adjustment coefficient adj_coef based on cur_lum and start_lum.

Further, the pixel adjustment coefficient may be determined with reference to formula (8).

505. Adjust the pixel value of the image based on the pixel adjustment coefficient adj_coef.

Further, a product of the pixel adjustment coefficient adj_coef and an original pixel value of the current frame of image may be determined as a target pixel value of the current frame of image.

507. Determine whether cur_lum is greater than or equal to dst_dark_lum that finally needs to be reached.

When cur_lum is greater than dst_dark_lum, step 504 is performed, and the display screen luminance needs to be further reduced. When cur_lum is less than or equal to dst_dark_lum, the display screen luminance has reached lowest luminance, step 508 is performed, and the display luminance adjustment process ends.

508. End.

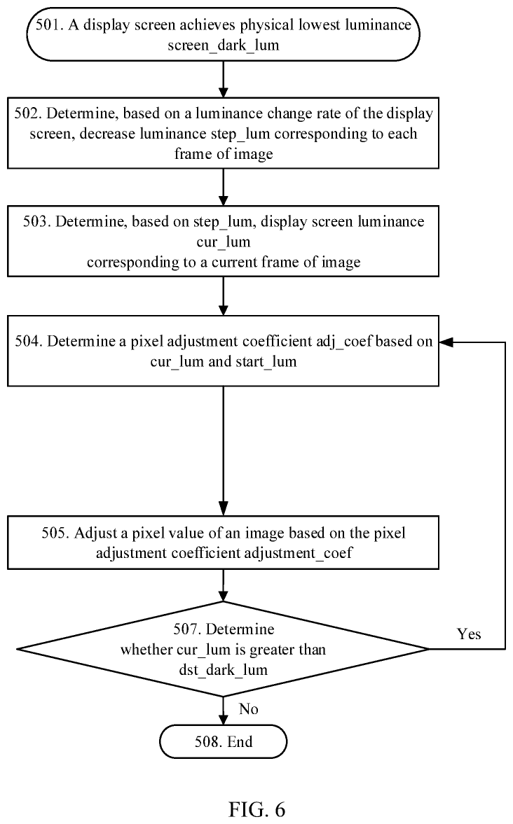

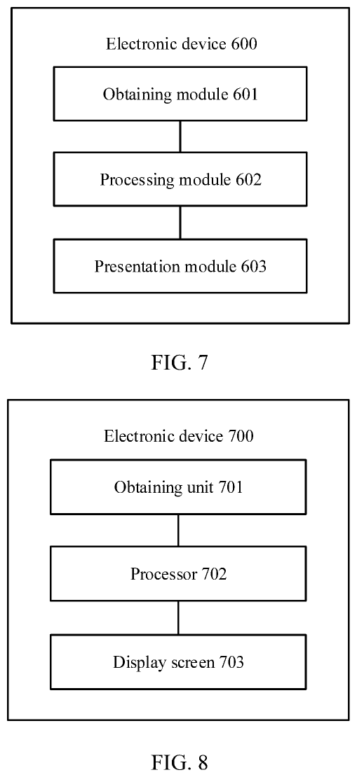

The foregoing describes in detail the display luminance adjustment method in the embodiments of this application with reference to FIG. 1 to FIG. 6. The following describes electronic devices in the embodiments of this application with reference to FIG. 7 and FIG. 8. It should be understood that, the electronic devices in FIG. 7 and FIG. 8 correspond to the steps of the display luminance adjustment method in the foregoing embodiments of this application. The electronic devices in FIG. 7 and FIG. 8 can perform the steps of the display luminance adjustment method in the foregoing embodiments of this application. For brevity, repeated descriptions are appropriately omitted below.

FIG. 7 is a schematic block diagram of an electronic device according to an embodiment of this application. The electronic device 600 shown in FIG. 7 further includes an obtaining module 601, a processing module 602, and a presentation module 603. Specific functions of the modules are as follows.

The obtaining module 601 is configured to obtain an initial luminance value of a display screen and an ambient light signal.

The processing module 602 is configured to determine a target luminance value of the display screen based on the ambient light signal, and obtain a target pixel value of a to-be-displayed image based on the initial luminance value, the target luminance value, and a current pixel value of the to-be-displayed image.

The presentation module 603 is configured to present the to-be-displayed image based on the target pixel value of the to-be-displayed image.

FIG. 8 is a schematic block diagram of an electronic device according to an embodiment of this application. The electronic device 700 shown in FIG. 8 includes an obtaining unit 701, a processor 702, and a display screen 703. Specific functions of the modules are as follows.

The obtaining unit 701 is configured to obtain an initial luminance value of a display screen and an ambient light signal.

The processor 702 is configured to determine a target luminance value of the display screen based on the ambient light signal, and obtain a target pixel value of a to-be-displayed image based on the initial luminance value, the target luminance value, and a current pixel value of the to-be-displayed image.

The display screen 703 is configured to present the to-be-displayed image based on the target pixel value of the to-be-displayed image.

The obtaining unit 701 in FIG. 8 corresponds to the obtaining module 601 in FIG. 7. The obtaining unit 701 and the obtaining module 601 may be signal obtaining modules inside the electronic devices. The signal obtaining module may directly obtain some information presented when the electronic device works. For example, the signal obtaining module may directly obtain the initial luminance value of the display screen from the display screen of the electronic device. In addition, the signal obtaining module may further obtain information about an external environment using a sensor of the electronic device. For example, the signal obtaining module may further obtain, from an ambient light sensor of the electronic device, the ambient light signal used to represent intensity of external ambient light.

The processor 702 in FIG. 8 corresponds to the processing module 602 in FIG. 7. The processor 702 or the processing module 602 may be a central processing unit (CPU) of the electronic device, or another chip, of the electronic device, that has a signal processing function.

The display screen 703 in FIG. 8 corresponds to the presentation module 603 (which may also be a display module) in FIG. 7, and is configured to display an image.

The electronic devices shown in FIG. 7 and FIG. 8 may be further mobile phones, computers (for example, personal computers or tablet computers), PDAs, wearable devices, other devices having a display function, or the like.

A person of ordinary skill in the art may be aware that, in combination with the examples described in the embodiments disclosed in this specification, units and algorithm steps may be implemented by electronic hardware or a combination of computer software and electronic hardware. Whether these functions are performed by hardware or software depends on a specific application and a design constraint of the technical solution. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented using some interfaces. The indirect couplings or communication connections between the apparatuses or units may be implemented in electrical, mechanical, or other forms.

The units described as separate parts may or may not be physically separate, and components displayed as units may or may not be physical units, may be located in one position, or may be distributed on a plurality of network units. Some or all of the units may be selected based on actual requirements to achieve the objectives of the solutions of the embodiments.

In addition, the functional units in the embodiments of this application may be integrated into one processing unit, each of the units may exist alone physically, or two or more units are integrated into one unit.

When the functions are implemented in a form of a software functional unit and sold or used as an independent product, the functions may be stored in a computer-readable storage medium. Based on such an understanding, the technical solution of this application essentially, a part contributing to other approaches, or a part of the technical solution may be embodied in a form of a software product. The computer software product is stored in a storage medium, and includes several instructions for enabling a computer device (which may be a personal computer, a server, or a network device) to perform all or some of the steps of the methods described in the embodiments of this application. The foregoing storage medium includes any medium that can store program code, such as a Universal Serial Bus (USB) flash drive, a removable hard disk, a read-only memory (ROM), a random-access memory (RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of the present application shall be subject to the protection scope of the claims.

1. A display luminance adjustment method comprising:
obtaining an initial luminance value of a display screen;
obtaining an ambient light signal;
determining a target luminance value of the display screen based on the ambient light signal;
obtaining a target pixel value of a to-be-displayed image based on the initial luminance value, the target luminance value, and a current pixel value of the to-be-displayed image; and
presenting the to-be-displayed image on the display screen based on the target pixel value.

2. The display luminance adjustment method of claim 1, further comprising controlling the to-be-displayed image to gradually change from the current pixel value to the target pixel value, wherein a first change rate at which the to-be-displayed image gradually changes from the current pixel value to the target pixel value is directly proportional to a second change rate at which the initial luminance value changes to the target luminance value in a unit time.

3. The display luminance adjustment method of claim 1, further comprising:
determining a pixel adjustment coefficient of the to-be-displayed image based on the initial luminance value and the target luminance value; and
obtaining the target pixel value further based on the pixel adjustment coefficient.

4. The display luminance adjustment method of claim 3, further comprising setting a product of the pixel adjustment coefficient and the current pixel value as the target pixel value.

5. The display luminance adjustment method of claim 1, further comprising:
adjusting an initial pixel adjustment coefficient based on the initial luminance value and the target luminance value to obtain a pixel adjustment coefficient of the to-be-displayed image, wherein the pixel adjustment coefficient is greater than or equal to the initial pixel adjustment coefficient; and
obtaining the target pixel value further based on the pixel adjustment coefficient.

6. The display luminance adjustment method of claim 5, wherein the to-be-displayed image comprises N frames of images, wherein N is a positive integer greater than or equal to 2, wherein the display luminance adjustment method further comprises adjusting the initial pixel adjustment coefficient to obtain a pixel adjustment coefficient of each of the N frames of images, and wherein pixel adjustment coefficients of the N frames of images are in an ascending order or a descending order.

7. The display luminance adjustment method of claim 1, further comprising:
determining a reference luminance value of the to-be-displayed image based on the initial luminance value, wherein the reference luminance value is either:
greater than or equal to the initial luminance value and less than or equal to the target luminance value; or
less than or equal to the initial luminance value and greater than or equal to the target luminance value;
obtaining a pixel adjustment coefficient of the to-be-displayed image based on either:
a first ratio of the reference luminance value to the initial luminance value; or
a second ratio of the reference luminance value to the target luminance value; and
obtaining the target pixel value based on the pixel adjustment coefficient and the current pixel value.

8. The display luminance adjustment method of claim 7, wherein the to-be-displayed image comprises N frames of images, wherein N is a positive integer greater than or equal to 2, and wherein the display luminance adjustment method further comprises adjusting the initial luminance value to obtain a second reference luminance value of each of the N frames of images.

9. The display luminance adjustment method of claim 7, further comprising:
determining a luminance adjustment step value; and
adjusting the initial luminance value based on the luminance adjustment step value to obtain the reference luminance value of the to be displayed image.

10. The display luminance adjustment method of claim 9, further comprising determining the luminance adjustment step value based on a luminance change rate of the display screen, wherein the luminance adjustment step value is in positive correlation to the luminance change rate.

11. The display luminance adjustment method of claim 9, wherein the to-be-displayed image comprises N frames of images, wherein N is a positive integer greater than or equal to 2, and wherein the display luminance adjustment method further comprises determining an i^{th} reference luminance value of an i^{th} image frame based on a formula:
ref_lum[i]=start_lum−i*step_lum,
wherein ref_lum [i] is the i^{th} reference luminance value, wherein start_lum is the initial luminance value, wherein step_lum is the luminance adjustment step value, and wherein i is a positive integer less than or equal to N.

12. The display luminance adjustment method of claim 1, wherein before presenting the to-be-displayed image on the display screen, the display luminance adjustment method further comprises: adjusting a display screen luminance, and wherein the display screen luminance is the target luminance value.

13. An electronic device, comprising:
a display screen; and
a processor coupled to the display screen and configured to:
obtain an initial luminance value of the display screen;
obtain an ambient light signal;
determine a target luminance value of the display screen based on the ambient light signal; and
obtain a target pixel value of a to-be-displayed image based on the initial luminance value, the target luminance value, and a current pixel value of the to-be-displayed image,
wherein the display screen is configured to present the to-be-displayed image based on the target pixel value.

14. The electronic device of claim 13, wherein the processor is further configured to: control the to-be-displayed image to gradually change from the current pixel value to the target pixel value, and wherein a first change rate at which the to-be-displayed image gradually changes from the current pixel value to the target pixel value is directly proportional to a second change rate at which the initial luminance value changes to the target luminance value in a unit time.

15. The electronic device of claim 13, wherein the processor is further configured to:
determine a pixel adjustment coefficient of the to-be-displayed image based on the initial luminance value and the target luminance value; and
obtain the target pixel value further based on the pixel adjustment coefficient.

16. The electronic device of claim 15, wherein the processor is further configured to determine a product of the pixel adjustment coefficient and the current pixel value as the target pixel value.

17. The electronic device of claim 13, wherein the processor is further configured to:
adjust an initial pixel adjustment coefficient based on the initial luminance value and the target luminance value to obtain a pixel adjustment coefficient of the to-be-displayed image, wherein the pixel adjustment coefficient is greater than or equal to the initial pixel adjustment coefficient; and
obtain the target pixel value further based on the pixel adjustment coefficient.

18. The electronic device of claim 17, wherein the to-be-displayed image comprises N frames of images, wherein N is a positive integer greater than or equal to 2, wherein the processor is further configured to adjust the initial pixel adjustment coefficient to obtain a pixel adjustment coefficient of each of the N frames of images, and wherein pixel adjustment coefficients of the N frames of images are in an ascending order or a descending order.

19. The electronic device of claim 13, wherein the processor is further configured to:
determine a reference luminance value of the to-be-displayed image based on the initial luminance value, wherein the reference luminance value is either:
greater than or equal to the initial luminance value and less than or equal to the target luminance value; or
less than or equal to the initial luminance value and greater than or equal to the target luminance value;
obtain a pixel adjustment coefficient of the to-be-displayed image based on either:
a first ratio of the reference luminance value to the initial luminance value; or
a second ratio of the reference luminance value to the target luminance value; and
obtain the target pixel value based on the pixel adjustment coefficient and the current pixel value.

20. The electronic device of claim 19, wherein the to-be-displayed image comprises N frames of images, wherein N is a positive integer greater than or equal to 2, and wherein the processor is further configured to adjust the initial luminance value to obtain a second reference luminance value of each of the N frames of images.

21. The electronic device of claim 19, wherein the processor is further configured to:
determine a luminance adjustment step value; and
adjust the initial luminance value based on the luminance adjustment step value to obtain the reference luminance value.

22. The electronic device of claim 21, wherein the processor is further configured to determine the luminance adjustment step value based on a luminance change rate of the display screen, and wherein the luminance adjustment step value is in positive correlation to the luminance change rate.

23. The electronic device of claim 21, wherein the to-be-displayed image comprises N frames of images, wherein N is a positive integer greater than or equal to 2 wherein the processor is further configured to determine an i^{th} reference luminance value of an i^{th} image frame based on a formula:
ref_lum[i]=start_lum−i*step_lum,
wherein ref_lum [i] is the i^{th} reference luminance value, wherein start_lum is the initial luminance value, wherein step_lum is the luminance adjustment step value, and wherein i is a positive integer less than or equal to N.

24. The electronic device of claim 13, wherein before the display screen presents the to-be-displayed image, the processor is further configured to adjust a display screen luminance, and wherein the display screen luminance is the target luminance value.
